(19) United States
(12) Patent Application Publication
(10) Pub. No.: US 2004/0120309 A1
(43) Pub. Date: Jun. 24, 2004

(54) Methods for changing the size of a jitter buffer and for time alignment, communications system, receiving end, and transcoder

(76) Inventors: Antti Kurittu, Vantaa (FI); Olli Kirla, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/475,779

(22) PCT Filed: Apr. 24, 2001
(86) PCT No.: PCT/EP01/04608

(51) Int. Cl. H04L 12/66

(52) U.S. Cl. 370/352; 370/516

(57) ABSTRACT

The invention relates to a method for changing the size of a jitter buffer, which jitter buffer is employed at a receiving end in a communications system including a packet network for buffering received packets containing audio data in order to enable a compensation of varying delays of said received packets. In order to enable a faster change of the jitter buffer size it is proposed that in case it is determined that the current jitter buffer size has to be changed, the jitter buffer size is expanded by generating additional data based on the received data or decreased by compacting the received data. A proposed communications system, receiving end and processing unit include corresponding means. The invention equally relates to a method for time alignment in a radio communications system based on existing speech data. A further proposed communications system, transceiver unit and processing unit include the corresponding means.

### FIELD OF THE INVENTION

The invention relates to a method for changing the size of a jitter buffer, which jitter buffer is employed at a receiving end in a communications system including a packet network for buffering received packets containing audio data in order to enable a compensation of varying delays of said received packets. The invention moreover relates to such a communications system, to such a receiving end and to processing means for such a receiving end. The invention equally relates to a method for carrying out a time alignment in a network transcoder of a radio communications system, which time alignment is used for decreasing a buffering delay in downlink direction, said buffering delay resulting from buffering downlink speech data encoded by said transcoder before transmitting said speech data over a radio interface of said radio communications system in order to compensate for a phase shift in a downlink framing of said speech data in said transcoder and at said radio interface. Further, the invention relates to such a radio communications system and to a transcoder for a radio communications system.

### BACKGROUND OF THE INVENTION

An example of a packet network is a voice over IP (VOIP) network.

IP telephony or voice over IP (VOIP) enables users to transmit audio signals like voice over the Internet Protocol. Sending voice over the internet is done by inserting speech samples or compressed speech into packets. The packets are then routed independently from each other to their destination according to the IP-address included in each packet.

One drawback in IP telephony is the availability and performance of networks. Although the local networks might be stable and predictable, the Internet is often congested and there are no guarantees that packets are not lost or significantly delayed. Lost packets and long delays have an immediate effect on speech quality, reciprocity and the pace of conversation.

Because of the independent routing of the packets, the packets moreover take variable times to go through the network. The variation in packet arrival times is called jitter. To play out the voice in the receiving end correctly, though, the packets must be in the order of transmission and equally spaced. To achieve this requirement a jitter buffer can be employed. The jitter buffer can be located before or after a decoder used at the receiving end for decoding the speech which was encoded for transmission. In the jitter buffer, the right order of packets can then be assured by checking sequence numbers contained in the packets. Equally contained timestamps can further be used to determine the jitter level in the network and for compensating for the jitter in play out.

The size of the jitter buffer, however, has a contrary effect on the number of packets that are lost and on the end-to-end delay. If the jitter buffer is very small, many packets are lost because they have arrived after their playout point. On the other hand, if the jitter buffer is very large an excessive end-to-end delay appears. Both, packet loss and end-to-end delay, have an effect on speech quality. Therefore, the size of the jitter buffer has to result in an acceptable value for both, packet loss and delay. Since both can vary in time, adaptive jitter buffers have to be employed in order to be able to continuously guarantee a good compromise for the two factors. The size of an adaptive jitter buffer can be changed based on measured delays of received speech packets and measured delay variances between received speech packets.

Known methods adjust the jitter buffer size in the beginning of a talkspurt. At the beginning of a talkspurt and therefore at the end of a pause in speech, the played out speech is not affected by the adjustment of the jitter buffer size. This means, however, that an adjustment has to be delayed until a beginning of a talkspurt occurs and that a voice activity detector (VAD) is needed. Such methods are described e.g. in “An algorithm for playout of packet voice based on adaptive adjustment of talkspurt silence periods”, LCN '99, Conference on Local Computer Networks, 1999, Pages 224-231, by J. Pinto and K. J. Christensen, and in “Adaptive playout mechanisms for packetized audio applications in wide-area networks”, INFOCOM '94, 13th Proceedings IEEE Networking for Global Communications, 1994, Pages 680-688, vol.2, by R. Ramjee, J. Kurose, D. Towsley and H. Schulzrinne.

A similar problem with jitter buffers can arise e.g. in voice over ATM networks.

A similar problem can moreover arise during time alignment in GSM (global system for mobile communications) or 3G (third generation) systems. In radio communications systems like GSM or a 3G system, the air interface requires a tight synchronization between uplink and downlink transmission. However, at the start of call or after a handover, the initial phase shift between uplink and downlink framing in a transcoder used on the network side for encoding data for downlink transmissions and decoding data from uplink transmissions is different from the corresponding phase shift at the radio interface. This phase shift can also be seen in the phase shift only of the downlink framing in the transcoder and at a radio interface of the radio communications system. Therefore, a downlink buffering is needed to achieve a correct synchronization for the air interface, which buffer is included in GSM in a base station and in 3G networks in a radio network controller (RNC) of the communications system. The buffering leads to an additional delay of up to one speech frame in the base station in downlink direction. To minimize this buffering delay, a time alignment procedure can be utilized on the network side. The time alignment is used to align the phase shift in the framing of the transcoder and thus to minimizing the buffering delay after a call set-up or handover. During the time alignment, the base station or radio network controller requests the transcoder to carry out a desired time alignment. In the time alignment, the transmission time instant of an encoded speech frame and the following frames need to be advanced or delayed. Thereby the window (one speech frame) of input buffer of linear samples before the encoder has to be slided in to the desired direction by the amount of samples requested by the base station. Presently, a time alignment is carried out by dropping or repeating speech samples, which leads to a deterioration of the speech quality.

### SUMMARY OF THE INVENTION

For a first aspect of the invention, it is an object to enable a faster adaptation of the size of a jitter buffer to changing conditions in voice over IP transmissions.

This object is reached on the one hand with a method for changing the size of a jitter buffer, which jitter buffer is employed at a receiving end in a communications system including a packet network for buffering received packets containing audio data in order to enable a compensation of varying delays of said received packets. According to the method of the first aspect of the invention, in a first step, it is determined whether a current jitter buffer size should be increased or decreased by evaluating current overall delay and jitter in received packets. In a second step, in case it was determined that the current jitter buffer size is to be increased, increasing the jitter buffer size and compensating the resulting empty jitter buffer space by generating additional data based on audio data contained in received packets.

On the other hand, the object is reached with a communications system including a packet network and at least one possible receiving end, the receiving end including a jitter buffer for buffering received packets containing audio data. The receiving end further includes processing means for compensating varying delays of received packets buffered in said jitter buffer. Moreover, it includes processing means for determining whether the size of said jitter buffer should be increased or decreased based on the current overall delay and the current variation of delay between the different packets. In addition, processing means are included in the receiving end for changing the current size of the jitter buffer according to the method of the invention. The object is equally reached with such a receiving end for a communications system including a packet network.

Finally, the object is reached with processing means for a receiving end for a communications system including a packet network, which processing means are designed for changing the current size of a jitter buffer according to the method of the invention.

The first aspect of the invention proceeds from the idea that the size of a jitter buffer could be adapted to the present conditions of transmission immediately, i.e. for example also during ongoing audio transmissions like active speech, if an empty space resulting in an increased jitter buffer is compensated. This is achieved according to the invention by creating additional data based on the existing data whenever the jitter buffer size has to be increased.

It is thus an advantage of the invention that it enables in a simple way a faster adaptation to changed transmission conditions. More specifically, the jitter buffer size can be changed immediately after the decision that a increase of the jitter buffer size is necessary was made, instead of waiting for a pause in audio.

The packet network can be in particular a voice over internet protocol or a voice over ATM network.

Preferred embodiments of this first aspect of the invention become apparent from the subclaims 2 to 22, 24 and 26.

Advantageously, though not necessarily, whenever it was determined that the current jitter buffer size is to be decreased, the jitter buffer size is moreover decreased by condensing at least part of the audio data currently present in the jitter buffer. In case also a decrease of the jitter buffer is thus carried without waiting for a pause in speech, no voice activity detector is needed, since it is no longer necessary to detect speech pauses.

There exists a variety of possibilities for expanding or contracting the existing jitter buffer data in order to compensate for an increase or decrease of the jitter buffer size. Basically five preferred embodiments will be presented.

In a first preferred embodiment of the invention for increasing the jitter buffer size, some known bad frame handling method is employed for increasing the jitter buffer size, i.e. an empty jitter buffer space is treated as if the corresponding packets were lost during transmission, which loss has to be concealed.

In particular, the bad frame handler defined in ITU-T Recommendation G.711, Appendix I: “A high quality low-complexity algorithm for packet loss concealment with G.711”, September 1999, can be employed for increasing the jitter buffer size. This bad frame handler employs a pitch waveform replication. Pitch waveform replications are based on the quasi-periodic nature of voiced audio signals, which means that the contents of consecutive packets are likely to resemble one another. A gap can therefore be filled by replicating one or more pitch periods of previous packets.

To ensure a smooth transition between the real and the synthesized audio signal, a predetermined number of samples of the real and the synthesized audio signal can be overlap added. For the same reason, repeated pitch period length waveforms may be overlap added.

If the jitter buffer size is increased by many packets at once, phonemes become unnaturally long. To compensate for this effect, the increase in jitter buffer size could be distributed to several small increases of only one added packet at a time. This would increase signal variation, as synthesizing one packet would be done from two valid packets instead of synthesizing all required packets from the pitch buffer, resulting in a better sound quality. However, when increasing the jitter buffer in small steps, it is not possible to respond to variable network delays as fast as with producing many synthesized packets at once. Therefore it is proposed that when the jitter buffer size has to be increased by several packets, rather all packets are generated at once and the resulting data is attenuated in order to prevent that the sound quality suffers.

In a first preferred embodiment of the invention for decreasing the jitter buffer size, two selected frames are overlapped, the frames in between being discarded. The frames that are overlapped are selected in a distance with which the desired decrease in jitter buffer size can be achieved. In case a decrease by only one frame is to be achieved, two consecutive frames are selected. This embodiment results in a simple implementation requiring little computational power.

Advantageously, the first frame in time used for overlapping is first multiplied with a downramp function and the second frame in time used for overlapping is first multiplied with an upramp function. For carrying out the overlapping, the products are then added.

A second and a third preferred embodiment of the invention for increasing and decreasing a jitter buffer size are based on time scaling, which enable a stretching or compressing of a selected segment of data in a buffer.

In the second preferred embodiment, a time domain time scaling is employed.

In time domain time scaling based jitter buffer size change methods, first data is selected from the received data that is to be used for time scaling. Then some time scaling method is used to time scale the selected part of speech. This new time scaled signal can then be used to replace at least part of the firstly selected signal, thus compensating for the change in jitter buffer size.

A time domain time scaling method of good quality and with low computational power is the Waveform Similarity OverLap Add (WSOLA), which was described for example by W. Verhelst and M. Roelands in “An overlap-add technique based on waveform similarity (WSOLA) for high quality time-scale modification of speech”, ICASSP-93., IEEE International Conference on Acoustics, Speech, and Signal Processing, 1993., Volume 2, Pages 554-557. The Waveform Similarity OverLap Add method is based on constructing a synthetic waveform that maintains maximal local similarity to the original signal. The synthetic waveform and the original waveform have maximal similarity around time instances specified by a time warping function.

The time domain scaling method can be used for time scale expanding or compressing and thus for increasing or decreasing the employed size of a jitter buffer.

At the transition from the time scaled data to the following data, the pitch period may not correspond to the original pitch period. In order to decrease this effect of phase mismatches between time scaled data and the following real data, the time scaling can be extended for a predetermined length, preferably for an additional ½ packet length. The extension of the time scaled signal which is not required for substituting received audio data in the jitter buffer is overlapped with the following real data.

According to the third preferred embodiment, a frequency domain time scaling is employed for generating additional data or for condensing the existing data.

In a frequency domain time scaling, first overlapping windowed parts of the original data are Fourier transformed. Then, a time scale modification is applied. The modification depends on the one hand on whether an increase or a decrease of the jitter buffer size is to be compensated. On the other hand it depends on the amount of the increase or decrease. After the time scale modification, inverse Fourier transformations are applied to the time scale modified, Fourier transformed data. Because of the time scale modification, the distance between the analysis windows applied to the original data is different from the distance between the synthesis windows resulting in the inverse Fourier transformation. Depending on the time scale modification, the resulting data is thus expanded or compressed compared to the original data. Therefore, also this method can be used equally for adding and for removing data for an increase or decrease of the employed size of a jitter buffer.

In particular, a phase vocoder time scale modification method described for example in “Applications of Digital Signal Processing to Audio and Acoustics”, Kluver Academic Pub; ISBN: 0792381300, 1998, by K. Brandenburg and M. Kahrs can be used for the third preferred embodiment of the invention. This method is based on taking short-time Fourier transforms (STFT) of a speech signal.

While the first three presented preferred embodiments of the invention proceed from decoded audio signals, the invention can be employed in a fourth preferred embodiment with parametric audio signal coding. In this case, the jitter buffer size can be increased according to a known bad frame handling. This can be carried out for example with a bad frame handler of the coder.

An example for a bad frame handler that could be employed in the fourth preferred embodiment of the invention is the error concealment in Enhanced Full Rate (EFR) codec described in “Substitution and muting of lost frames for Enhanced Full Rate (EFR) speech traffic channels (GSM 06.61 version 8.0.0 Release 1999). Digital cellular telecommunications system (Phase 2+)”, ETSI EN 300 727 v.8.0.0, March 2000, which is used in the GSM. This document specifies a frame (packet) substitution and muting procedure for one or more consecutive lost frames. If applied to empty frames resulting from an increase of the jitter buffer size, the first empty frame is replaced by repeating the last frame received before the empty frame. If more than one consecutive empty frame had to be inserted, substituting will be done by copying the last received frame for each missing frame and decreasing the output level by 3 dB/frame. The output level scaling is done by scaling the codebook gains and by modifying the LSF parameters.

If the size of the jitter buffer is to be decreased with parametric audio signal coding, some number of frames are discarded. The gain parameters and Linear Predictive Coding (LPC) coefficients of the frames surrounding the discarded frame or frames can be modified to smoothly combine the frames surrounding the discarded frame or frames. Alternatively, the frame or frames can be discarded without any further amendments.

Also the fifth preferred embodiment for increasing and decreasing the jitter buffer size is intended for parametric audio data coding.

In the fifth preferred embodiment for increasing the jitter buffer size, additional data is interpolated from adjacent parametric coded audio data. In the fifth preferred embodiment for decreasing the jitter buffer size, the contained parametric coded audio data is reduced by interpolating selected audio data into less audio data. The selected audio data can be adjacent or spaced apart, in which case the data in between the selected data is discarded.

Also time scaling can be employed on parametric coded audio data.

While five different preferred basic embodiments of the invention were presented, numerous alternative or modified embodiments are included in the scope of the invention. In particular, the invention can be realized based on any other suitable time scaling and/or bad frame handling method for compensating for a change in the size of the jitter buffer.

For example, if time scaling is to employed, a first time scaling method can be employed for a time scale expansion and another method for a time scale compression.

While an increase of the jitter buffer size is preferably carried out immediately after an increase was determined to be necessary, a required decrease of the jitter buffer size can be postponed until a pause in speech appears, in case a Voice Activity Detector is available, since decreasing the jitter buffer size is not as time critical as increasing the jitter buffer size.

If a bad frame handling method is used, an existing bad frame handler can be used for dealing in addition with changes in the jitter buffer size.

For a second aspect of the invention, it is an object of the invention to improve the time alignment in radio communications systems.

This object is reached on the one hand with a method for carrying out a time alignment in a network transcoder of a radio communications system, which time alignment is used for decreasing a buffering delay in downlink direction, said buffering delay resulting from buffering downlink speech data encoded by said transcoder before transmitting said speech data over a radio interface of said radio communications system in order to compensate for a phase shift in a downlink framing of said speech data by said transcoder and by said radio interface. First, it is determined whether a time alignment has to be carried out.

In a first alternative in the method proposed for the second aspect of the invention, in case it was determined that a time alignment has to be carried out, selected speech data is expanded or compacted with a time scaling method for achieving the required time alignment.

In a second alternative in the method proposed for the second aspect of the invention, in case it was determined that a time alignment has to be carried out, selected speech data is expanded for achieving the required time alignment by inserting an empty space within said selected speech data, said empty space being compensating by a bad frame handling.

In a third alternative in the method proposed for the second aspect of the invention, in case it was determined that a time alignment has to be carried out, speech data is condensed for achieving the required time alignment by overlapping a selected first portion of speech data and a selected second portion of speech data, the speech data in between said first and said second selected portion of the speech data being discarding.

In a fourth alternative in the method proposed for the second aspect of the invention, in case it was determined that a time alignment has to be carried out, speech data is condensed for achieving the required time alignment by discarding at least one frame of speech data. Gain parameters and Linear Predictive Coding (LPC) coefficients of frames of speech data surrounding the at least one discarded frame are moreover modified to smoothly combine the frames surrounding the at least one discarded frame.

In a fifth alternative in the method proposed for the second aspect of the invention, in case it was determined that a time alignment has to be carried out, speech data is expanded for achieving the required time alignment by interpolating additional audio data from selected speech data.

In a sixth alternative in the method proposed for the second aspect of the invention, in case it was determined that a time alignment has to be carried out, speech data is expanded for achieving the required time alignment by interpolating selected adjacent or spaced apart speech data into reduced speech data.

The object of the second aspect of the invention is reached on the other hand with a radio communications system comprising at least one radio interface for transmitting encoded speech data in a downlink direction and at least one network transcoder. Said network transcoder includes at least one encoder for encoding speech data to be used for a downlink transmission via said radio interface. The network transcoder further includes processing means for carrying out a time alignment on encoded speech samples according to one of the proposed methods of the second aspect of the invention. The radio communications system moreover comprises buffering means arranged between said radio interface and said network transcoder for buffering downlink speech data encoded by said transcoder before transmitting said encoded speech data via said radio interface in order to compensate for a phase shift in a downlink framing of said speech data by said transcoder and by said radio interface. Finally, the radio communications system comprises processing means for determining whether and to which extend the speech samples encoded by said encoder have to be time aligned before transmission in order to minimize a buffering delay for encoded speech data resulting from a buffering by said buffering means. The object of the second aspect of the invention is equally reached with such a network transcoder for a radio communications system.

The second aspect of the invention proceeds from the idea that the time alignment in a network transcoder of a radio communications system could be achieved with less effect on the encoded speech samples, if it is not carried out by simply dropping or repeating speech samples, but rather by compensating for the time alignment in a more sophisticated way that results in less effect on the quality of the speech data. There are six different possibilities proposed for such a compensation of a time alignment, all ensuring only smooth transitions within the aligned speech data. It is thus an advantage of the invention that it enables in a simple way an improved time alignment.

It is to be noted that strictly speaking the mentioned phase shift relates to the time difference of sending and receiving the first data bit of a frame on uplink vs. downlink, i.e. how data frames aligned in time at an observation point in different transmission directions. For GSM, e.g., initially this time difference is not equal between air and a bis interfaces. After the time alignment, the time difference should be almost equal, i.e. minimal buffering.

It becomes apparent that both aspects of the invention are based on the same principle, i.e. changing the amount of currently available audio data based on this existing audio data such that a necessary change can be achieved without severe deterioration of the audio data during ongoing transmission.

Preferred embodiments of this first aspect of the invention become apparent from the subclaims 29 to 34, 36 to 38 and 40.

They correspond to the preferred embodiments of different possibilities for time scaling described for the first aspect of the invention.

The second aspect of the invention can be employed in particular, though not exclusively, in a Media Gateway as well as in GSM and 3G time alignments.

### BRIEF DESCRIPTION OF THE FIGURES

In the following, the invention is explained in more detail with reference to drawings, of which

FIG. 1 illustrates the principle of three embodiments of the invention for changing the jitter buffer size;

FIG. 2 shows diagrams illustrating an increase in jitter buffer size according to the first embodiment of the invention based on a method for bad frame handling;

FIG. 3 shows diagrams illustrating a decrease in jitter buffer size according to the first embodiment of the invention;

FIG. 4 shows diagrams illustrating the principle of a time domain time scaling according to a second embodiment of the invention is based;

FIG. 5 is a flow chart of the second embodiment of the invention;

FIG. 6 shows diagrams further illustrating the second embodiment of the invention;

FIG. 7 shows diagrams illustrating the principle of a third embodiment of the invention based on frequency domain time scaling;

FIG. 8 is a flow chart of the third embodiment of the invention;

FIG. 9 shows jitter buffer signals before and after time scaling according to the third embodiment of the invention;

FIG. 10 is a flow chart illustrating a fourth embodiment of the invention changing a jitter buffer size in the parametric domain;

FIG. 11 schematically shows a part of a first system in which the invention can be employed;

FIG. 12 schematically shows a part of a second system in which the invention can be employed; and

FIG. 13 schematically shows a part of a first system in which the invention can be employed; and

FIG. 14 schematically shows a communications system in which a time alignment according to the invention can be employed.

### DETAILED DESCRIPTION OF THE INVENTION

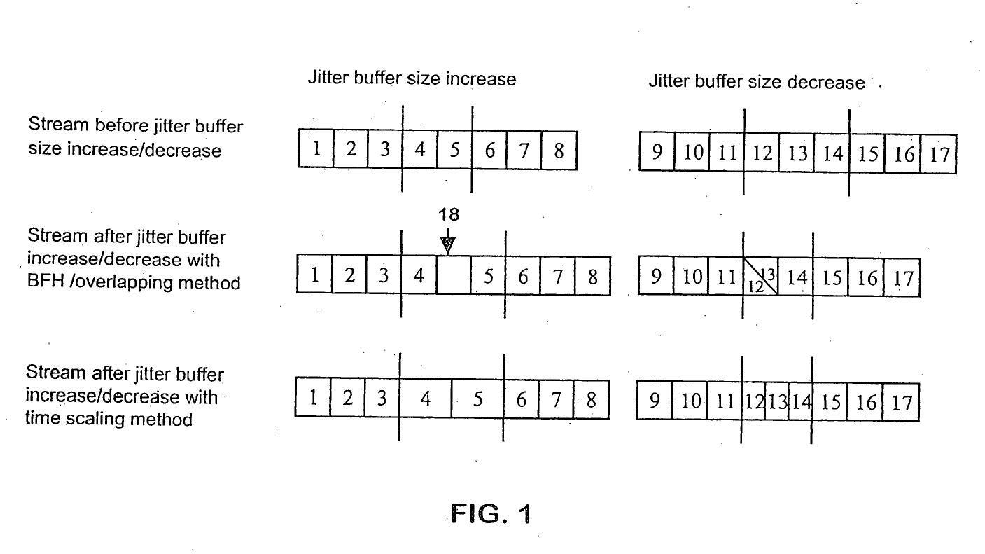

FIG. 1 illustrates the basic principles of the first three embodiments of the invention that will be presented.

On the left hand side of the figure, an increase of a packet stream is shown, while on the left hand side, a decrease of a packet stream is shown. The upper part of the figure shows for both cases original streams, the middle part for both cases streams treated according to the first embodiment of the invention and the lower part for both cases streams treated according to the second or third embodiment of the invention.

In the upper left part of FIG. 1, a first packet stream with eight original packets 1 to 8 including speech data is indicated. This packet stream is contained in a jitter buffer of a receiving end in a voice over IP network before an increase of the jitter buffer size becomes necessary. In the upper right part of FIG. 1, a second packet stream with nine packets 9 to 17 including speech data is indicated. This packet streams is contained in a jitter buffer of a receiving end in a voice over IP network before a decrease of the jitter buffer size becomes necessary.

On the left hand side in the middle of FIG. 1, the first packet stream is shown after an increase of the jitter buffer size. The jitter buffer size was increased by providing an empty space of the length of one packet between the original packet 4 and the original packet 5 of the packet stream in the jitter buffer. This empty space is filled by a packet 18 generated according to a bad frame handling BFH as defined in the above mentioned ITU-T G.711 codec, the empty space simply being considered as lost packet. The size of the original stream is thus expanded by the length of one packet.

On the right hand side in the middle of FIG. 1, in contrast, the second packet stream is shown after a decrease of the jitter buffer size. It is realized in the first described embodiment by overlapping two consecutive packets, in this example, the original packet 12 and the original packet 13 of the second packet stream. The overlapping reduces the number of speech samples contained in the jitter buffer in the length of one packet, the size of which can thus be reduced by the length of one packet.

On the left hand side at the bottom of FIG. 1, the first packet stream is shown again after an increase of the jitter buffer size which resulted in an empty space of the length of one packet between the original packets 4 and 5 of the first packet stream. This time, however, the original packets 4 and 5 were time scaled in the time domain or in the frequency domain according to the second or third embodiment of the invention in order to fill the resulting empty space. That means the data of original packets 4 and 5 was expanded to fill the space of three instead of two packets. The size of the original stream was thus expanded by the length of one packet.

On the right hand side at the bottom of FIG. 1, finally, the second packet stream is shown again after a decrease of the jitter buffer size. The corresponding decrease of the data stream was realized according to the second or third embodiment by time scaling the data of three original packets to the length of two packets. In the presented example, the data of the original packets 12 to 14 of the second packet stream were condensed to the length of two packets. The size of the original stream was thus reduced by the length of one packet.

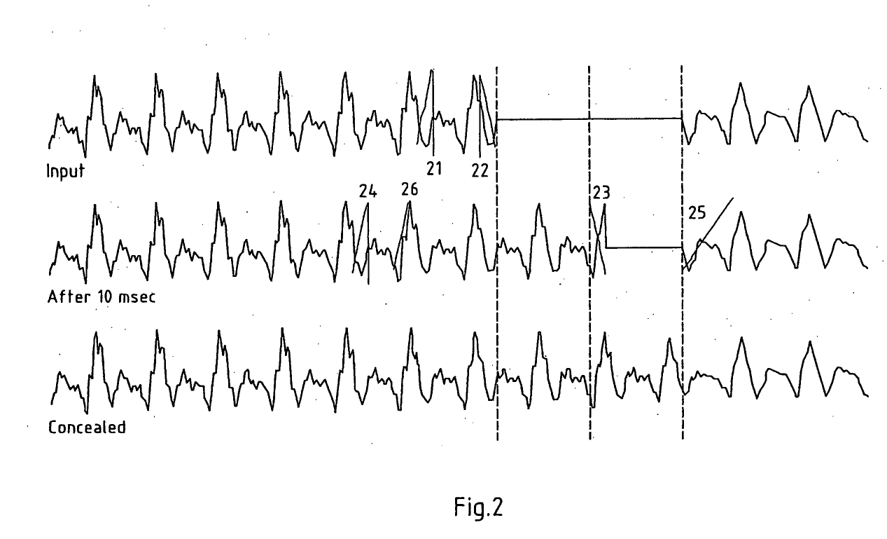

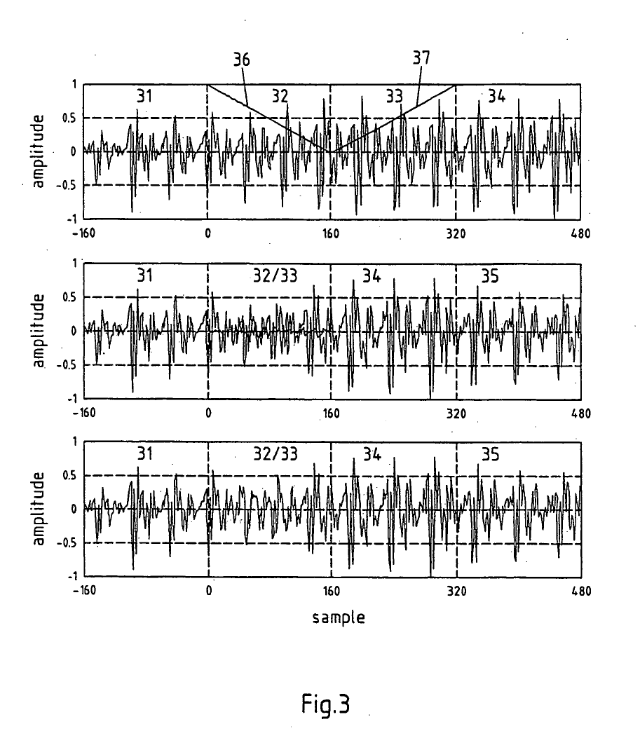

The increase and decrease of the jitter buffer size according to the first embodiment of the invention will now be explained in detail with reference to FIGS. 2 and 3.

FIG. 2 is taken from the ITU-T G.711 Appendix specification, where it is used for illustrating lost packet concealment, while here it is used for illustrating the first embodiment of the invention, in which the ITU-T bad frame handler is called between adjacent packets for compensating for an increase of the jitter buffer size.

FIG. 2 shows three diagrams which depict the amplitude of signals over the sample number of the signals. In the first diagram the signals input to the jitter buffer are shown, while a second and third diagram show synthesized speech at two different points in time. The diagrams illustrate how the jitter buffer size is increased according to the first embodiment of the invention corresponding to a bad frame handling presented in the above cited ITU-T G.711 codec. As mentioned above, the cited standard describes a packet loss concealment method for the ITU-T G.711 codec based on pitch waveform replication.

The packet size employed in this embodiment is 20 ms, which corresponds to 160 samples. The BFH was modified to be able to use 20 ms packets.

The arrived packets as well as the synthesised packets are saved in a history buffer of a length of 390 samples.

After an increase of the size of the jitter buffer by the length of two packets, there is an empty space in the jitter buffer corresponding to two lost packets, indicated in the first diagram of FIG. 2 by a horizontal line connecting the received signals. At the start of each empty space, the contents of the history buffer are copied to a pitch buffer that is used throughout the empty space to find a synthetic waveform that can conceal the empty space. In the situation in the first diagram, the samples that are to the left of the two empty packets i.e. the samples that have arrived before the increase of size, form the current content of the pitch buffer.

A cross-correlation method is now used to calculate a pitch period estimate from the pitch buffer. As illustrated in the second diagram of FIG. 2, the first empty packet is then replaced by replicating the waveform that starts one pitch period length back from the end of the history buffer, indicated with a vertical line referred to by 21, in the required number. To ensure a smooth transition between the real and the synthesized speech, as well as between repeated pitch period length waveforms, the last 30 samples in the history buffer, in the region limited by a vertical and an inclined line referred to by 22 in the first diagram, are overlap added with the 30 samples preceding the synthetic waveform in the region limited by the vertical line 21 and a connected inclined line. The overlapped signal replaces the last 30 samples 22 in the pitch buffer. This overlap add procedure causes an algorithmic delay of 3.75 ms, or 30 samples. In the same way, a smooth transition between repeated pitch period length waveforms is ensured.

The synthetic waveform is moreover extended beyond the duration of the empty packets to ensure a smooth transition between the synthetic waveform and the subsequently received signal. The length of the extension 23 is 4 ms. In the end of the empty space, the extension is raised by 4 ms per additional added empty packet. The maximum extension length is 10 ms. In the end of the empty space this extension is overlapped with the signal of the first packet after the empty space, the overlap region being indicated in the figure with the inclined line 25. The second diagram of FIG. 2 illustrates the state of the synthesized signal after 10 ms, when samples of one packet length have been replicated.

In case there is a second added empty packet, as in the first diagram of FIG. 2, another pitch period is added to the pitch buffer. Now the waveform to be replicated is two pitch periods long and starts from the vertical line referred to by 24. Next, the 30 samples 24 before the pitch buffer are overlap added with the last 30 samples 22 in the pitch buffer. Again, the overlapped signal replaces the last 30 samples in region 22 in the pitch buffer. A smooth transition between one and two pitch period length signals is ensured by performing an overlap add between the regions indicated by 23 and 26. Region 26 is placed by subtracting pitch periods until the pitch pointer is in the first wavelength of the currently used portion of the pitch buffer. The result of the overlap adding replaces the samples in region 23. The third diagram of FIG. 2 shows the synthesized signal in which an empty space of the length of two packets added for an increase in the size of the jitter buffer was concealed.

If the size of the jitter buffer is further increased, another pitch period would be added to the pitch buffer.

However, if the increase in jitter buffer size is large it is more likely that the replacement signal falsifies the original signal. Attenuation is used to diminish this problem. The first replacement packet is not attenuated. The second packet is attenuated with a linear ramp. The end of the packet is attenuated by 50% compared to the start with the used packet size of 20 ms. This attenuation is also used for the following packets. This means that after 3 packets (60 ms) signal amplitude is zero.

Similarly, parametric speech coders' bad frame handling methods can be employed for compensating for an increase of the jitter buffer size.

FIG. 3 illustrates how the jitter buffer size is decreased according to the first embodiment of the invention by overlapping two adjacent packets. To this end, the figure shows three diagrams depicting the amplitude of signals over the sample number of the signals.

The first diagram of FIG. 3 shows the signals of four packets 31-34 presently stored in a jitter buffer before a decrease in size, each packet containing 160 samples. Now, the size of the jitter buffer is to be decreased by one packet. To this end, two adjacent packets 32, 33 are multiplied with a downramp 36 and an upramp 37 function respectively, as indicated in the first diagram. Then, the multiplied packets 32, 33 of the signals are overlapped, which is shown in the second diagram of FIG. 3. Finally, the overlapped part of the signal 32/33 is added as shown in the third diagram of FIG. 3, the fourth packet now being formed by the packet 35 following the original fourth packet 34. The result of the overlap adding is a signal comprising one packet less than the original signal, and this removed packet enables a decrease of the size of the jitter buffer.

When the jitter buffer size is to be decreased by more than one packet at a time, not adjacent but spaced apart packets are overlap added, and the packets in between are discarded. For example, if the jitter buffer size is to be changed from three packets to one, the first packet in the jitter buffer is overlap added with the third packet in the jitter buffer as described for packets 32 and 33 with reference to FIG. 3, and the second packet is discard.

In a second embodiment of the invention, an immediate increase and decrease of a jitter buffer size is enabled by a time domain time scaling method, and more particularly by a waveform similarity overlap add (WSOLA) method described in the above mentioned document “An overlap-add technique based on waveform similarity (WSOLA) for high quality time-scale modification of speech”.

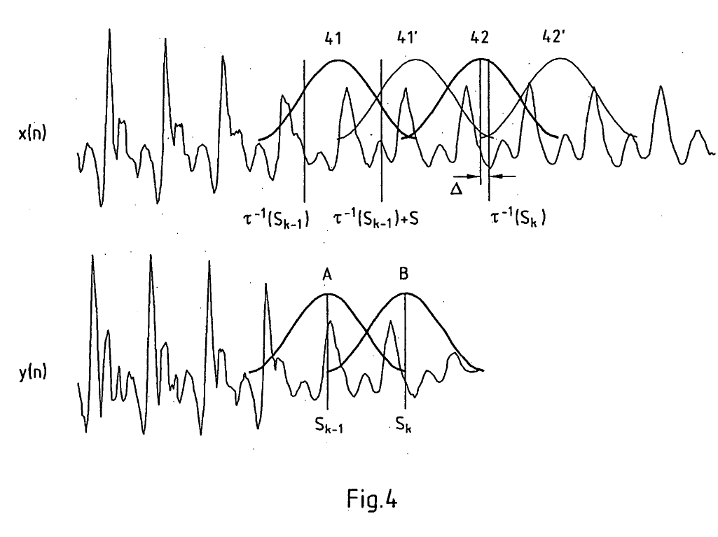

The WSOLA method is illustrated for an exemplary time scaling resulting in a reduction of samples of a signal in FIG. 4, which comprises in the upper part an original waveform x(n) and in the lower part a synthetic waveform y(n) constructed with suitable values of the original waveform x(n). n indicates the respective sample of the signals. The WSOLA method is based on constructing a synthetic waveform that maintains maximal local similarity to the original signal. The synthetic waveform y(n) and original waveform x(n) have maximal similarity around time instances specified by a time warping function τ⁻¹ (n).

In FIG. 4, the input segment 41 of original waveform x(n) was the last segment excised from the original waveform x(n). This segment 41 is the last segment that was added as a synthesis segment A to the synthesized waveform y(n). Segment A was overlap-added to the output signal y(n) at time Sₖ₋₁=(k−1)S, S being the interval between segments in the synthesized signal y(n).

The next synthesis segment B is to be excised from the input signal x(n) around time instant τ⁻¹ (Sₖ), and overlap added to the output signal y(n) at time Sₖ=kS. As can be seen in the figure, segment 41′ of the input signal x(n) would overlap perfectly with segment 41 of the input signal x(n). Segment 41′ is therefore used as a template when choosing a segment 42 around time instant τ⁻¹ (Sₖ) of the input signal x(n) which is to be used as next synthesis segment B. A similarity measure between segment 41′ and segment 42 is computed to find the optimal shifting value A that maximizes the similarity between the segments. The next synthesis segment B is thus selected by finding the best match 42 for the template 41′ around time instant τ⁻¹ (Sₖ). The best match must be within the tolerance interval of Δ, which tolerance interval lies between a predetermined minimum Δₘᵢₙ and a predetermined maximum Δₘₐₓ value. After overlap-adding the synthesis segment 42 to the output signal as segment B, segment 42′ of the input signal x(n) is used as the next template.

The WSOLA method uses regularly spaced synthesis instants Sₖ=kS. The analysis and synthesis window length is constant. If the analysis/synthesis window is chosen in such a way that,

$${\sum }_{k}^{} v ( n - kS ) = 1 \qquad ( 1 )$$

and if the analysis/synthesis window is symmetrical, the synthesis equation for the WSOLA method is

$$y ( n ) = {\sum }_{k}^{} v ( n - kS ) x ( n + {τ}^{- 1} ( kS ) - kS + {Δ}_{k} ) . \qquad ( 2 )$$

By selecting a different time warping function, the same method can be employed not only for reducing the samples of a signal but also for increasing the amount of samples of a signal.

It is important that the transition from the original signal to the time-scaled signal is smooth. In addition, the pitch period should not change during the jumps from the signal used as received to the time scaled signal. As was explained previously, WSOLA time scaling preserves the pitch period. However, when time scaling is performed for a part in the middle of the speech signal, some discontinuity on either the beginning, or the end of the time scaled signal can not be avoided sometimes.

In order to decrease the effect of such a phase mismatch, it is proposed for the second embodiment of the invention to slightly modify the method described with reference to FIG. 4. The modified WSOLA (MWSOLA) method uses history information and extra extension to decrease the effect of this problem.

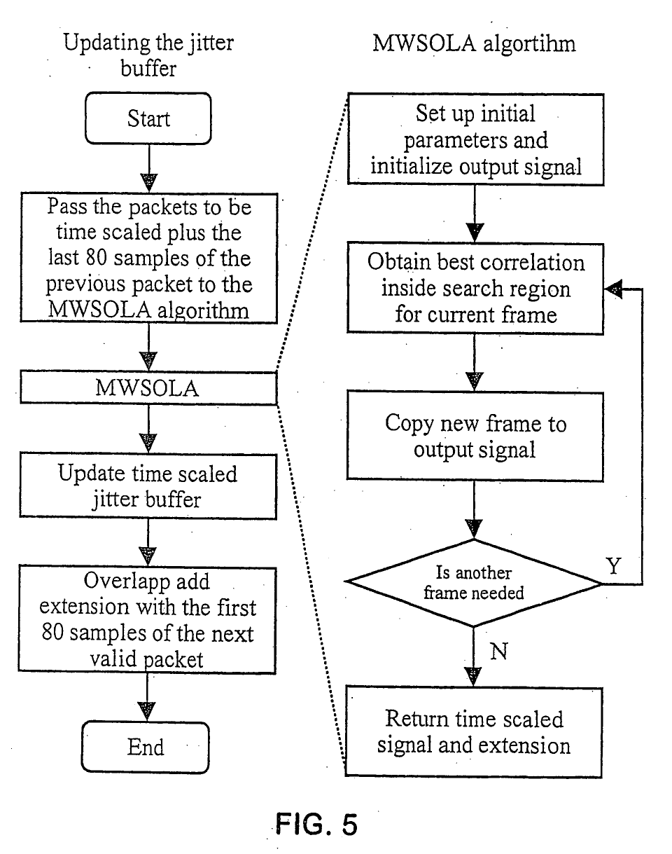

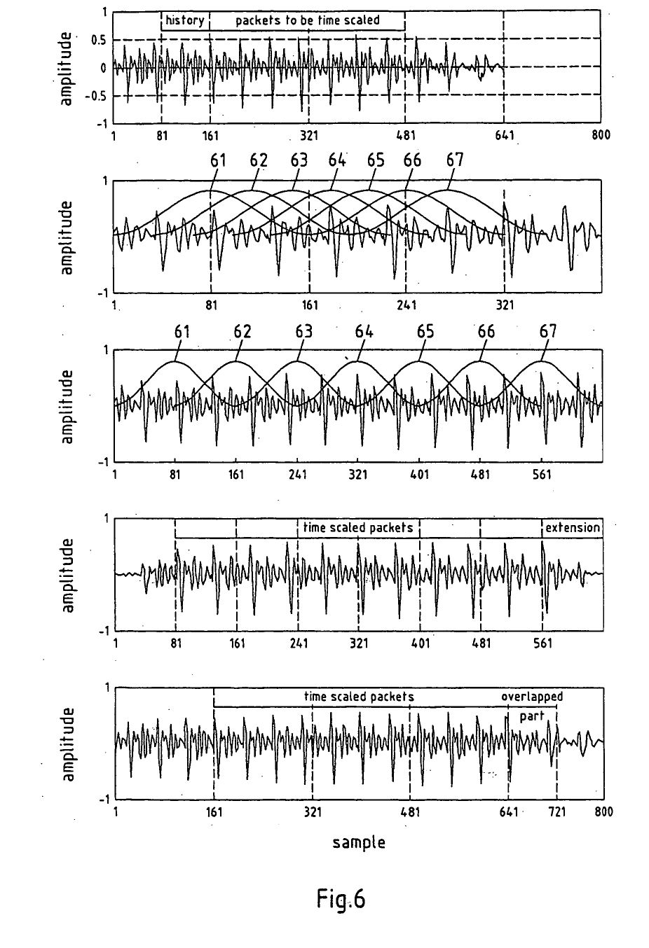

A MWSOLA algorithm using an extension of the time scale for an extra half of a packet length will now be described with reference to the flow chart of FIG. 5 and to the five diagrams of FIG. 6. The used packet size is 20 ms, or 160 samples, the sampling rate being 8 kHz. The analysis/synthesis window used has the same length as the packets.

FIG. 5 illustrates the basic process of updating the jitter buffer size using the proposed MWSOLA algorithm. As shown on the left hand side of the flow chart of FIG. 5, first the packets to be time scaled are chosen. In addition, ½ packet length of the previously arrived signal, i.e. 80 samples, are selected as history samples. The selected samples are also indicated in the first diagram of FIG. 6. After being selected, they are forwarded to the MWSOLA algorithm.

The MWSOLA algorithm, which is shown in more detail on the right hand side of FIG. 5, is then used to provide the desired time scaling on the selected signals as described with reference to FIG. 4.

The analysis/synthesis window is created by modifying a Hanning window so that the condition of equation (1) is fulfilled. The time warping function τ⁻¹ (n) is constructed differently for time scale expansion and compression, i.e. for an increase and for a decrease of the jitter buffer size. The time warping function and the limits of the search region Δ (Δ=[Δₘᵢₙ . . . Δₘₐₓ]) are chosen in such a way that a good signal variation is obtained. By setting the limits of the search region and the time warping function correctly, it can be avoided that adjacent analysis frames are chosen repeatedly. Finally, the first frame from the input signal is copied to an output signal which is to substitute the original signal. This ensures that the change from the preceding original signal to the time scaled signal is smooth.

After the initial parameters like the time warping function and the limits for the search region are set and an output signal is initialized, a loop is used to find new frames for the time scaled output signal as long as needed. A best match between the last L samples of the previous frame and the first L samples of the new frame is used as an indicator in finding the next frame. The used length L of the correlation is ½ * window length=80 samples. The search region Δ (Δ=[Δₘᵢₙ . . . Δₘₐₓ]) should be longer than the maximum pitch period in samples, so that a correct synchronization between consecutive frames is possible.

The second diagram of FIG. 6 shows how the analysis windows 61-67 defining different segments are placed in the MWSOLA input signal when time scaling two packets to three packets.

The third diagram of FIG. 6 shows how overlapping the synthesis segments succeeded. As can be seen, the different windows 61-67 overlap, in this case, quite nicely.

Overlap adding of all the analysis/synthesis frames results in the time scaled signal shown in the fourth diagram of FIG. 6, which constitutes the output signal of the MWSOLA algorithm. The MWSOLA algorithm returns the new time scaled packets and an extension to be overlap added with the first ½ packet length of the next arriving packet.

As shown again on the left hand side of the flow chart of FIG. 5., the jitter buffer is then updated with the time scaled signals and the extension is overlap added with the next arriving packet. The resulting signal can be seen in the fifth diagram of FIG. 6.

This procedure decreases the effect of the phase and amplitude mismatches between the time-scaled signal and the valid signal.

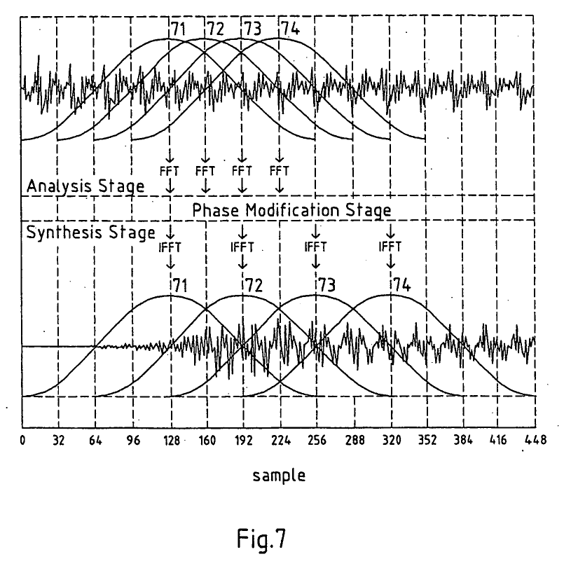

A phase vocoder based jitter buffer scaling method will now be described with reference to FIGS. 7 to 9 as third embodiment of the invention. This method constitutes a frequency domain time scaling method.

The phase vocoder time scale modification method is based on taking short-time Fourier transforms (STFT) of the speech signal in the jitter buffer as described in the above mentioned document “Applications of Digital Signal Processing to Audio and Acoustics”. FIG. 7 illustrates this technique. The phase vocoder based time scale modification comprises an analyzing stage, indicated in the upper part of FIG. 7, a phase modification stage indicated in the middle of FIG. 7, and a synthesis stage indicated in the lower part of FIG. 7.

In the analyzing stage, short-time Fourier transforms are taken from overlapping windowed parts 71-74 of a received signal. In particular, discrete time Fourier transforms (DFT) as described by J. Laroche and M. Dolson in “Improved Phase Vocoder Time-Scale Modification of Audio”, IEEE Transactions on Speech and Audio Processing, Vol. 7, No. 3, May 1999. pp. 323-332, can be employed in the phase vocoder analysis stage. This means that both, the frequency scale and the time scale representation of the signal, are discrete. The analysis time instants tₐ^{u} are regularly spaced by Rₐ samples, tₐ^{u}=u*Rₐ. Rₐ is called the analysis hop factor. The short time Fourier transform is then

$$X ( {t}_{a}^{u} , {Ω}_{k} ) = {\sum }_{n = - ∞}^{∞} h ( n ) x ( {t}_{a}^{u} + n ) {ⅇ}^{- {jΩ}_{k} n} , \qquad ( 3 )$$

where x is the original signal, h(n) the analysis window and. Ωₖ=2 pi*k/N the center frequency of the k^{th} vocoder channel. The vocoder channels can also be called bins. N is the size of the DFT, where N must be longer than the length of the analysis window; In practical solutions, the DFT is usually obtained with the Fast Fourier Transform (FFT). The analysis window's cutoff frequency for the standard (Hanning, Hamming) windows requires the analysis windows to overlap by at least 75%. After the analysis FFT, the signal is represented by horizontal vocoder channels and vertical analysis time instants.

In the phase modification stage, the time scale of the speech signal is modified by setting the analysis hop factor Rₐ different from a to be used synthesis hop factor Rₛ, as described in the mentioned document “Improved Phase Vocoder Time-Scale Modification of Audio”. The new time-evolution of the sine waves is achieved by setting |Y(tₛ^{u}, Ωₖ)|=|X(tₐ^{u}, Ωₖ)| and by calculating new phase values for Y(tₛ^{u}, Ωₖ).

The new phase values for Y(tₛ^{u}, Ωₖ) are calculated as follows. A process called phase unwrapping is used, where the phase increment between two consecutive frames is used to estimate the instantaneous frequency of a nearby sinusoid in each channel k. First the heterodyned phase increment is calculated by

ΔΦₖ^{u}=∠X(tₐ^{u},Ωₖ)−∠X(tₐ^{u-1},Ωₖ)−RₐΩₖ. (4)

Then by adding or subtracting multiples of 2π so that the result of (7) lies between ±π, the principal determination (ΔₚΦₖ^{u}) of the heterodyned phase increment is obtained. The instantaneous frequency is then calculated using

$${ω}_{k} ( {t}_{a}^{u} ) = {Ω}_{k} + \frac{1}{{R}_{a}} {Δ}_{p} {Φ}_{k}^{u} . \qquad ( 5 )$$

The instantaneous frequency is determined because the FFT is calculated only for discrete frequencies Ωₖ. Thus the FFT does not necessarily represent the windowed signal exactly.

The time scaled phases of the STFT at a time tₛ^{u} are calculated from

∠Y(tₛ^{u},Ωₖ)=∠Y(tₛ^{u-1},Ωₖ)+Rₛωₖ(tₐ^{u}). (6)

The choice of initial synthesis phases ∠Y(tₛ⁰,Ωₖ) is important for good speech quality. In the above mentioned document “Improved Phase Vocoder Time-Scale Modification of Audio”, a standard initialization setting of

∠Y(tₛ⁰,Ωₖ)=∠X(tₐ⁰,Ωₖ) (7)

is recommended, which makes a switch from a non time scaled signal to a time scaled signal possible without phase discontinuity. This is an important attribute for jitter buffer time scaling.

After the phases values for Y(tₛ^{u}, Ωₖ) are obtained, the signal can be reconstructed in a synthesis stage.

In the synthesis stage, the modified short time Fourier transforms Y(tₛ^{u}, Ωₖ) are first inverse Fourier transformed with the equation

$${y}_{u} ( n ) = \frac{1}{N} {\sum }_{k = 0}^{N - 1} Y ( {t}_{s}^{u} , {Ω}_{k} ) {ⅇ}^{j {Ω}_{k} u} , \qquad ( 8 )$$

The synthesis time instants are set tₛ^{u}=u*Rₛ. Finally the short-time signals are multiplied by a synthesis window w(n) and are summed, together giving the output signal y(n):

$$y ( n ) = {\sum }_{u = - ∞}^{∞} w ( n - {t}_{s}^{u} ) {y}_{u} ( n - {t}_{s}^{u} ) . \qquad ( 9 )$$

The distance between the analysis windows is different from the distance between the synthesis windows due to the time scale modification, therefore a time extension or compression of the received jitter buffer data is achieved. Synchronisation between overlapping synthesis windows was achieved by modifying the phases in the STFT.

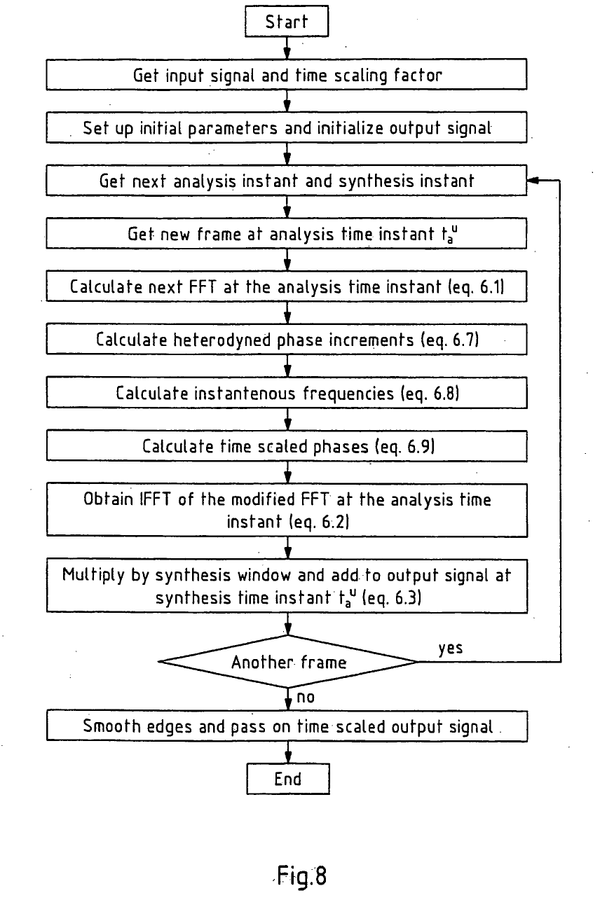

The use of the phase vocoder based time scaling for increasing or decreasing the size of a jitter buffer is illustrated in the flow chart of FIG. 8.

First, the input signal is received and a time scaling factor is set.

The algorithm is then initialized by setting analysis and synthesis hop sizes, and by setting the analysis and synthesis time instants. When doing this, a few constraints have to be taken into account, which have been listed e.g. in the above mentioned document “Applications of Digital Signal Processing to Audio and Acoustics”. The cutoff frequency of the analysis window must satisfy wₕ<minᵢΔwᵢ, i.e. the cutoff frequency must be less than the spacing between two sinusoids. Further, the length of the analysis window must be small enough so that the amplitudes and instantaneous frequencies of the sinusoids can be considered constants inside the analysis window. Finally, to enable phase unwrapping, the cutoff frequency and the analysis rate must satisfy wₕRa<π. The cutoff frequency for standard analysis windows (Hamming, Hanning) is wₕ≈4π/Nw, where Nw is the length of the analysis window.

As further initial parameter, the number of frames to process is calculated. This number is used to determine how many times the following loop in FIG. 8 must be processed. Finally, initial synthesis phases are set, according to equation (7).

After initialization, a vocoder processing loop follows for the actual time scaling. Inside the phase vocoder processing loop, the routine is a straightforward realization of the method presented above. First, the respective next analysis frame is obtained by multiplying the signal with the analysis window at time instant tₐ^{u}. Then the FFT of the frame is calculated. The heterodyned phase increment is calculated by setting Rₐ in equation (4) to tₐ^{u}−tₐ^{u-1}. Instantaneous frequencies are also obtained by setting Rₐ in equation (5) to tₐ^{u}−tₐ⁻¹. The time scaled phases are obtained from equation (6). Next, the IFFT of the modified FFT of the current frame is calculated according to equation (8). The result of equation (8) is then multiplied by the synthesis window and added to the output signal. Before going through the loop again, the previous analysis and synthesis phases to be used in equations (4) and (6) are updated.

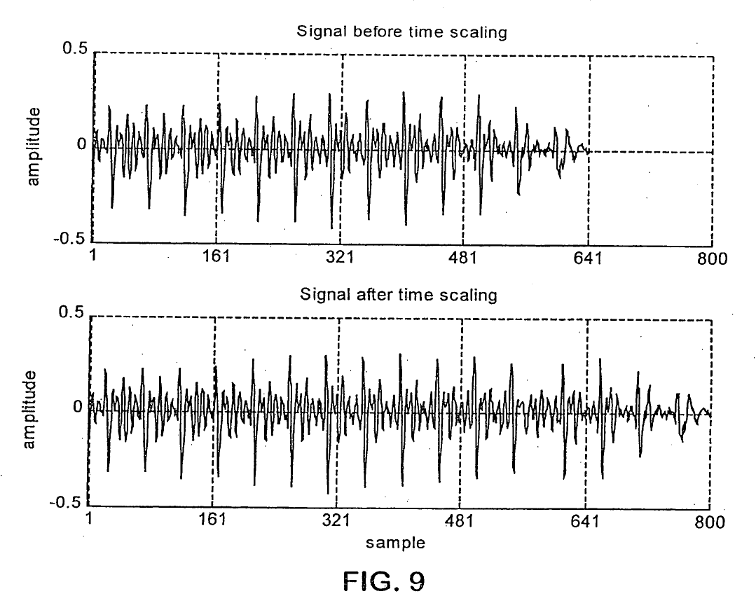

Finally, before outputting the time scaled signal, transitions between the time scaled and the non time scaled signal are smoothed. After this, the jitter buffer size modification can be completed. FIG. 9 shows the resulting signal when time scaling two packets into three with the phase vocoder based time scaling. In a first diagram of FIG. 9, the amplitude of the signal over the samples before time scaling is depicted. In a second diagram of FIG. 9, the amplitude of the signal over the samples after time scaling is depicted. The two packets with samples 161 to 481 in the first diagram were expanded to three packets with samples 161 to 641.

Before the jitter buffer size is increased, an error concealment should be performed. Moreover, a predetermined number of packets should be received before the jitter buffer size is increased.

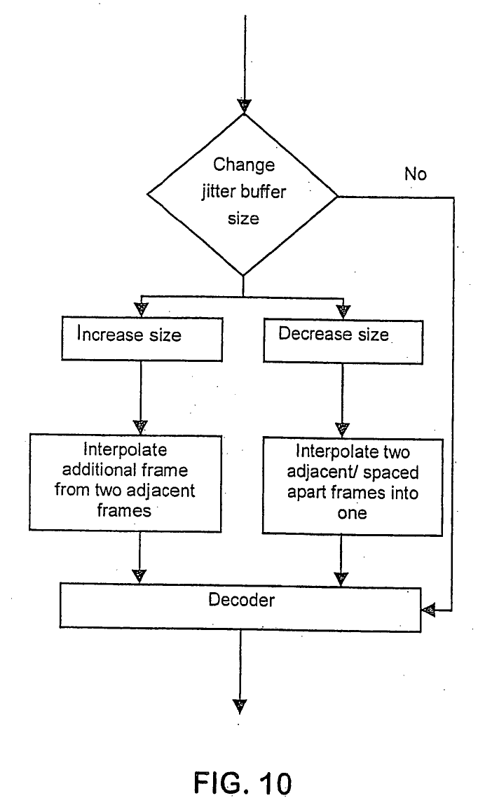

FIG. 10 is a flow chart illustrating a fourth embodiment of the invention, which can be used for changing a jitter buffer size in the parametric domain. The parametric coded speech frames are only decoded by a decoder after buffering in the jitter buffer.

In a first step, it is determined whether the jitter buffer size has to be changed. In case it does not have to be changed, the contents of the jitter buffer are directly forwarded to the decoder.

In case it is determined that the jitter buffer size has to be increased, the jitter buffer is increased and additional frames are generated by interpolating an additional frame from two adjacent frames in the parametric domain. The additional frames are used for filling the empty buffer space resulting from an increase in size. Only then the buffered frames are forwarded to the decoder.

In case it is determined that the jitter buffer size has to be decreased, the jitter buffer is decreased and two adjacent or spaced apart frames are interpolated in the parametric domain into one frame. The distance of the two frames used for interpolation to each other depends on the amount of the required decrease of the jitter buffer size. Only then the buffered frames are forwarded to the decoder.

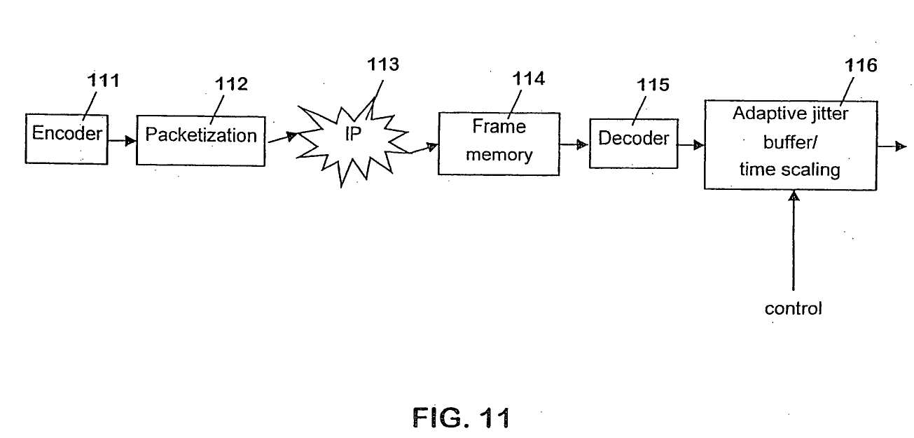

FIGS. 11 to 13 shows parts of three different voice over IP communications systems in which the invention might be employed.

In the communications system of FIG. 11, an encoder 111 and packetization means 112 belong to a transmitting end of the system. The transmitting end is connected to a receiving end via a voice over IP network 113. The receiving end comprises a frame memory 114, which is connected via a decoder 115 to an adaptive jitter buffer 116. The adaptive jitter buffer 116 further has a control input connected to control means and an output to some processing means of the receiving end which are not depicted.

At the transmitting end, speech that is to be transmitted is encoded in the encoder 111 and packetized by the packetization means 112. Each packet is provided with information about its correct position in a packet stream and about the correct distance in time to the other packets. The resulting packets are sent over the voice over IP network 113 to the receiving end.

At the receiving end, the received packets are first reordered in the frame memory 114 in order to bring them again into the original order in which they were transmitted by the transmitting end. The reordered packets are then decoded by the decoder 115 into linear PCM speech. The decoder 115 also performs a bad frame handling on the decoded data. After this, the linear PCM speech packets are forwarded by the decoder 115 to the adaptive jitter buffer 116. In the adaptive jitter buffer, a linear time scaling method can then be employed to increase or decrease the size of the jitter buffer and thereby get more time or less time for the packets to arrive to the frame memory.

The control input of the adaptive jitter buffer 116 is used for indicating to the adaptive jitter buffer 116 whether the size of the jitter buffer 116 should be changed. The decision on that is taken by control means based on the evaluation of the current overall delay and the current variation of delay between the different packets. The control means indicate more specifically to the adaptive jitter buffer 116 whether the size of the jitter buffer 116 is to be increased or decreased and by which amount and which packets are to be selected for time scaling.

In case the control means indicate to the adaptive jitter buffer 116 that its size is to be changed, the adaptive jitter buffer 116 time scales at least part of the presently buffered packets according to the received information, e.g. in a way described in the second or third embodiment. The jitter buffer 116 is therefore extended by time scale expansion of the currently buffered speech data and reduced by time scale compression of the currently buffered speech data. Alternatively, a method based on a bad frame handling method for increasing the buffer size could be employed for changing the jitter buffer size. This alternative method could for example be the method of the first embodiment of the invention, in which moreover data is overlapped for decreasing the buffer size.

The linear time scaling of FIG. 11 can be employed in particular for a low bit rate codec.

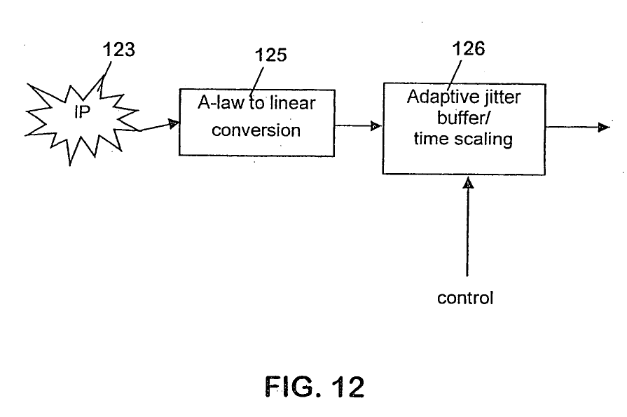

FIG. 12 shows a part of a communications system which is based on a linear PCM speech time scaling method. In this system, a transmitting end which corresponds to the one in FIG. 11 and which is not depicted in FIG. 12, is connected again via a voice over IP network 123 to the receiving end. The receiving end, however, is designed somewhat differently from the receiving end in the system of FIG. 11. The receiving end comprises now means for A-law to linear conversion 125 connected to an adaptive jitter buffer 126. The adaptive jitter buffer 126 has again additionally a control input connected to control means and an output to some processing means of the receiving end which are not depicted.

Packets containing speech data which were transmitted by the transmitting end and received by the receiving end via the voice over IP network 123 are first input to the means for A-law to liner conversion 125 of the receiving end, where they are converted to linear PCM data. Subsequently, the packets are reorganized in the adaptive jitter buffer 126. Moreover, the adaptive jitter buffer 126 takes care of a bad frame handling, before forwarding the packets with a correct delay to the processing means.

Control means are used again for deciding when and how to change the jitter buffer size. Whenever necessary, some time scaling method for linear speech, e.g. one of the presented methods, is then used in the adaptive jitter buffer 126 to change its size according to the information received by the control means. Alternatively, a method based on a bad frame handling method could be employed again for changing the jitter buffer, e.g. the method of the first embodiment of the invention. This alternative method could also make use of the bad frame handling method implemented in the jitter buffer anyhow for bad frame handling.

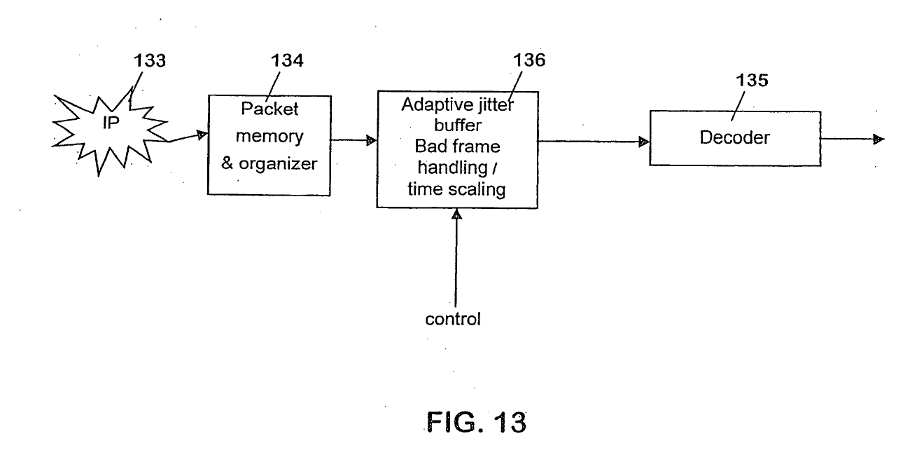

FIG. 13, finally, shows a part of a communications system in which a low bit rate codec and a parametric domain time scaling is employed.

Again, a transmitting end corresponding to the one in FIG. 11 and not being depicted in FIG. 13, is connected via a voice over IP network 133 to a receiving end. The receiving end comprises a packet memory and organizer unit 134, which is connected via an adaptive jitter buffer 136 to a decoder 135. The adaptive jitter buffer 136 further has a control input connected to control means, and the output of the decoder 135 is connected to some processing means of the receiving end, both, control means and processing means not being depicted.

Packets containing speech data which were transmitted by the transmitting end and received by the receiving end via the voice over IP network 133 are first reordered in the packet memory and organizer unit 134.

The reordered packets are then forwarded directly to the adaptive jitter buffer 136. The jitter buffer 136 applies a bad frame handling on the received packets in the parametric domain. The speech contained in the packets is decoded only after leaving the adaptive jitter buffer 136 in the decoder 135.

As in the other two presented systems, the control means are used for deciding when and how to change the jitter buffer size. Whenever necessary, some time scaling method for parametric speech is then used in the adaptive jitter buffer 136 to change its size according to the information received by the control means. Alternatively, also a bad frame handling method designed for bad frame handling of packets in the parametric domain could be employed for increasing the jitter buffer size. As further alternative, additional frames could be interpolated from two adjacent frames as proposed with reference to FIG. 10. Decreasing the jitter buffer size could be achieved by discarding a packet or by interpolating two packets into one in the parametric domain as proposed with reference to FIG. 10. In particular, if a decrease by more than one packet is desired, the packets around the desired amount of packets could be interpolated into one packet.

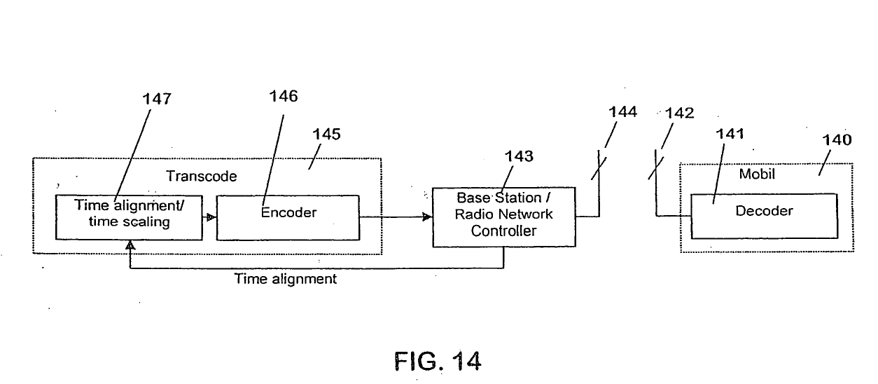

An embodiment of the second aspect of the invention relating to time alignment will now be presented with reference to FIG. 14, which shows a GSM or 3G radio communications system.

The radio communications systems comprises a mobile station 140, of which an antenna 141 and a decoder 142 are depicted. On the other hand, it comprises a radio access network, of which a base station and a radio network controller 143 is depicted as a single block with access to an antenna 144. Base station and radio network controller 143 are further connected to a network transcoder 145 comprising an encoder 146 and time alignment means 147 connected to each other. Base station or radio network controller 143 have moreover a controlling access to the time alignment means 147.

In the radio communications system, speech frames are transmitted in the downlink direction from the radio access network to the mobile station 140 and in the downlink direction from the mobile station 140 to the radio access network. Speech frames that are to be transmitted in the downlink direction are first encoded by the encoder 146 of the transcoder 145, transmitted via the radio network controller, the base station 143 and the antenna 144 of the radio access network, received by the antenna 142 of the mobile station 140 and decoded by the decoder 141 of the mobile station 140.

At the start of call or after a handover, the initial phase shift between uplink and downlink framing in the transcoder may be different from the phase shift of the radio interface, which prevents the required strict synchronous transmissions in uplink and downlink. In GSM, the base station 143 therefore guarantees that the phase shift is equal by buffering all encoded speech frames received from the transcoder 145 for a downlink transmission as long as required. Even though the base station 143 determines the required buffering delay by comparing uplink speech data received from the mobile station 140 with downlink speech data received from the transcoder 145, this means also a compensation of a phase shift of the downlink framing in the transcoder and at radio interface of the system accessed via the antenna 144. In a 3G network, this function is provided by the radio network controller 143. This buffering leads to an additional delay of up to one speech frame in the base station in downlink direction. In order to minimize the buffering delay required for synchronization, in GSM the base station and in 3G the radio network controller 143 requests from the time alignment means 147 of the transcoder 145 to apply a time alignment to the encoded speech frames.

In a time alignment, the transmission time instant of an encoded speech frame and the following frames is advanced or delayed for a specified amount of samples according to the information received the base station or the radio network controller 143 respectively, thus reducing the necessary buffering delay in the base station or the radio network controller 143.

According to the invention, the time alignment is now carried out by the time alignment means 147 by applying a time scaling on the speech frames encoded by the encoder 146, before forwarding them to the radio network controller or the base station 143. In particular, any of the time domain or frequency domain time scaling methods proposed for changing a jitter buffer size can be employed.

As a result, the buffering delay in the base station 143 is reduced as in a known time alignment, but the speech quality is affected less.

1. Method for changing the size of a jitter buffer, which jitter buffer is employed at a receiving end in a communications system including a packet network for buffering received packets containing audio data in order to enable a compensation of varying delays of said received packets, the method comprising:
determining whether a current jitter buffer size should be increased or decreased by evaluating current overall delay and jitter in received packets; and
in case it was determined that the current jitter buffer size is to be increased, increasing the jitter buffer size and compensating the resulting empty jitter buffer space by generating additional data based on audio data contained in received packets.

2. Method according to claim 1, wherein in case it was determined that the current jitter buffer size is to be decreased, decreasing the jitter buffer size by condensing at least part of the audio data currently present in the jitter buffer.

3. Method according to one of the preceding claims, wherein the audio data buffered in the jitter buffer is decoded audio data.

4. Method according to one of the preceding claims, wherein said additional data is generated by treating said empty jitter buffer space as lost frames and by compensating said empty jitter buffer space by a bad frame handling.

5. Method according to one of the preceding claims, wherein additional data is generated by replicating a waveform that starts a whole multitude of pitch period lengths before a point of time at which said additional data is to be added.

6. Method according to one of the preceding claims, wherein said additional data is generated to overlap part of received audio data in the jitter buffer.

7. Method according to one of the preceding claims, wherein at least part of said additional data is attenuated in case more than a predetermined amount of additional data is generated.

8. Method according to one of the preceding claims, wherein data is condensed by overlapping the audio data of a selected first packet (32) and the audio data of a selected second packet (33) and by discarding the packets in between said first and said second packet (32, 33).

9. Method according to claim 8, wherein audio data is overlapped by multiplying the audio data of a selected first packet (32) with a downramp function (36) and the audio data of a selected second packet (33) with an upramp function (37), by adding the multiplied data of said first and said second packet (32, 33), and by discarding the packets in between said first and said second packet (32, 33).

10. Method according to one of claims 1 to 3, wherein for changing the jitter buffer size, additional data is generated and/or audio data in said jitter buffer is condensed by a time domain time scaling performed on at least part of the audio data currently buffered in the jitter buffer for expanding or compressing said at least part of the audio data respectively.

11. Method according to claim 10, wherein the time domain time scaling comprises
a) selecting received audio data currently buffered in the jitter buffer, which audio data is to be used for time scaling;
b) applying a time domain time scaling method on the selected audio data for obtaining time scaled audio data; and
c) substituting in the jitter buffer the time scaled audio data for at least part of the selected received audio data.

12. Method according to claim 11, wherein the time scaling applied to selected received audio data is extended for a predetermined length surpassing the length to be used for substituting received audio data in the jitter buffer, which extension is overlapped with the following received audio data.

13. Method according to one of claims 10 to 12, wherein the time domain time scaling is based on a waveform similarity overlap add (WSOLA) method.

14. Method according to one of claims 1 to 3, wherein for changing the jitter buffer size additional data is generated and/or audio data in said jitter buffer is condensed by a frequency domain time scaling performed on at least part of the audio data currently buffered in the jitter buffer for expanding or compressing said at least part of the audio data respectively.

15. Method according to claim 14, wherein the frequency domain time scaling comprises:
Fourier transforming overlapping windowed parts (71-74) of at least part of the received audio data currently contained in the jitter buffer;
time scale modifying the Fourier transformed audio data of each window according to a required amount of increase or decrease of the jitter buffer size; and
inverse Fourier transforming the Fourier transformed and time scale modified audio data of each window.

16. Method according to claim 14 or 15, wherein the frequency domain time scaling is phase vocoder based.

17. Method according to one of claims 1 to 2, wherein the audio data buffered in the jitter buffer is parametric coded audio data.

18. Method according to claim 17, wherein for increasing the jitter buffer size additional data is generated by using a bad frame handler.

19. Method according to claim 17 or 18, wherein for decreasing the jitter buffer size the audio data in the jitter buffer is condensed by discarding at least one frame in the jitter buffer.

20. Method according to claim 19, wherein gain parameters and Linear Predictive Coding (LPC) coefficients of the frames surrounding the at least one discarded frame are modified to smoothly combine the frames surrounding the at least one discarded frame.

21. Method according to claim 17, wherein for increasing the jitter buffer size, additional audio data is interpolated from adjacent data.

22. Method according to claim 17, wherein for decreasing the jitter buffer size, selected adjacent or spaced apart audio data is interpolated into reduced audio data.

23. Communications system comprising a packet network and at least one possible receiving end, the receiving end including:
a jitter buffer for buffering received packets containing audio data;
processing means for compensating varying delays of received packets buffered in said jitter buffer;
processing means for determining whether the size of said jitter buffer should be increased or decreased-based on the current overall delay and the current variation of delay between the different packets; and
processing means for changing the current size of said jitter buffer according to one of the methods 1 to 22.

24. Communications system according to claim 23, wherein the receiving end further includes a bad frame handler for compensating packets lost during transmission to said receiving end, which bad frame handler is moreover employed for generating additional data for an increase of the jitter buffer size by the processing means for changing the current size of said jitter buffer.

25. Receiving end for a communications system including a packet network, which receiving end comprises:
a jitter buffer for buffering received packets containing audio data;
processing means for compensating varying delays of received packets buffered in said jitter buffer;
processing means for determining whether the size of said jitter buffer should be increased or decreased based on the current overall delay and the current variation of delay between the different packets; and
processing means for changing the current size of said jitter buffer according to one of the methods 1 to 22.

26. Receiving end according to claim 25, further including a bad frame handler for compensating packets lost during transmission to said receiving end, which bad frame handler is moreover employed for generating additional data for an increase of the jitter buffer size by the processing means for changing the current size of said jitter buffer.

27. Processing means for a receiving end of a communications system including a packet network, which processing means are designed for changing the current size of a jitter buffer according to one of the methods 1 to 22.

28. Method for carrying out a time alignment in a network transcoder (145) of a radio communications system, which time alignment is used for decreasing a buffering delay in downlink direction, said buffering delay resulting from buffering downlink speech data encoded by said transcoder (145) before transmitting said speech data over a radio interface of said radio communications system in order to compensate for a phase shift in downlink framing of speech data at said transcoder (145) and at said radio interface, the method comprising:
determining whether a time alignment has to be carried out; and
in case it was determined that a time alignment has to be carried out, expanding or compacting selected speech data with a time scaling method for achieving the required time alignment.

29. Method according to claim 28, wherein the time scaling method is a time domain time scaling method comprising
a) selecting original speech data which are to be used for time scaling;
b) applying a time domain time scaling method on the selected speech data for obtaining time scaled speech data; and
c) substituting the time scaled speech data for at least part of the selected speech data.

30. Method according to claim 28, wherein the time scaling applied to selected speech data is extended for a predetermined length surpassing the length to be used for substituting original speech data, which extension is overlapped with the following original speech data.

31. Method according to one of claims 28 to 30, wherein the time domain time scaling is based on a waveform similarity overlap add (WSOLA) method.

32. Method according to claim 28, wherein the time scaling is a frequency domain time scaling.

33. Method according to claim 32, wherein the frequency domain time scaling comprises:
Fourier transforming overlapping windowed parts of selected speech data;
time scale modifying the Fourier transformed speech data of each window according to the required time alignment; and
inverse Fourier transforming the Fourier transformed and time scale modified speech data of each window.

34. Method according to claim 32 or 33, wherein the frequency domain time scaling is phase vocoder based.

35. Method for carrying out a time alignment in a network transcoder of a radio communications system, which time alignment is used for decreasing a buffering delay in downlink direction, said buffering delay resulting from buffering downlink speech data encoded by said transcoder before transmitting said speech data over a radio interface of said radio communications system in order to compensate for a phase shift in a downlink framing of said speech data in said transcoder and at said radio interface, the method comprising:
determining whether a time alignment has to be carried out; and
in case it was determined that a time alignment has to be carried out, expanding selected speech data for achieving the required time alignment by inserting an empty space within said selected speech data and by compensating said empty space by a bad frame handling.

36. Method according to claim 35, wherein additional data is generated by replicating a waveform that starts a whole multitude of pitch period lengths before a point of time at which said additional data is to be added.

37. Method according to one of the claims 35 or 36, wherein said additional data is generated to overlap part of received audio data in the jitter buffer.

38. Method according to one of claims 35 to 37, wherein at least part of said additional data is attenuated in case more than a predetermined amount of additional data is generated.

39. Method for carrying out a time alignment in a network transcoder of a radio communications system, which time alignment is used for decreasing a buffering delay in downlink direction, said buffering delay resulting from buffering downlink speech data encoded by said transcoder before transmitting said speech data over a radio interface of said radio communications system in order to compensate for a phase shift in a downlink framing of said speech data in said transcoder and at said radio interface, the method comprising:
determining whether a time alignment has to be carried out; and
in case it was determined that a time alignment has to be carried out, condensing speech data for achieving the required time alignment by overlapping a selected first portion of speech data and a selected second portion of speech data and by discarding the speech data in between said first and said second selected portion of the speech data.

40. Method according to claim 39, wherein speech data is overlapped by multiplying the speech data of the selected first portion of speech data with a downramp function and the speech data of the selected second portion of speech data with an upramp function, by adding the multiplied data of said first and said second selected portion, and by discarding the speech data in between said first and said second portion.

41. Method for carrying out a time alignment in a network transcoder of a radio communications system, which time alignment is used for decreasing a buffering delay in downlink direction, said buffering delay resulting from buffering downlink speech data encoded by said transcoder before transmitting said speech data over a radio interface of said radio communications system in order to compensate for a phase shift in a downlink framing of said speech data in said transcoder and at said radio interface, the method comprising:
determining whether a time alignment has to be carried out; and
in case it was determined that a time alignment has to be carried out, condensing speech data for achieving the required time alignment by discarding at least one frame of speech data, wherein gain parameters and Linear Predictive Coding (LPC) coefficients of frames of speech data surrounding the at least one discarded frame are modified to smoothly combine the frames surrounding the at least one discarded frame.

42. Method for carrying out a time alignment in a network transcoder of a radio communications system, which time alignment is used for decreasing a buffering delay in downlink direction, said buffering delay resulting from buffering downlink speech data encoded by said transcoder before transmitting said speech data over a radio interface of said radio communications system in order to compensate for a phase shift in a downlink framing of said speech data in said transcoder and at said radio interface, the method comprising:
determining whether a time alignment has to be carried out; and
in case it was determined that a time alignment has to be carried out, expanding speech data for achieving the required time alignment by interpolating additional audio data from selected speech data.

43. Method for carrying out a time alignment in a network transcoder of a radio communications system, which time alignment is used for decreasing a buffering delay in downlink direction, said buffering delay resulting from buffering downlink speech data encoded by said transcoder before transmitting said speech data over a radio interface of said radio communications system in order to compensate for a phase shift in a downlink framing of said speech data in said transcoder and at said radio interface, the method comprising:
determining whether a time alignment has to be carried out; and
in case it was determined that a time alignment has to be carried out, expanding speech data for achieving the required time alignment by interpolating selected adjacent or spaced apart speech data into reduced speech data.

44. Radio communications system comprising
at least one radio interface for transmitting encoded speech data in a downlink direction;
at least one network transcoder (145), which network transcoder (145) includes at least one encoder (146) for encoding speech data to be used for a downlink transmission via said radio interface, and which network transcoder (145) further includes processing means (147) for carrying out a time alignment on encoded speech samples according to one of methods 28 to 43; and
buffering means (143) arranged between said radio interface and said network transcoder (145) for buffering downlink speech data encoded by said transcoder (145) before transmitting said encoded speech data via said radio interface in order to compensate for a phase shift in a downlink framing of said speech data by said transcoder (145) and by said radio interface; and
processing means (143) for determining whether and to which extend the speech samples encoded by said encoder (146) have to be time aligned before transmission in order to minimize a buffering delay for encoded speech data resulting from a buffering by said buffering means (143).

45. Network transcoder (145) for a radio communications system comprising:
at least one encoder (146) for encoding speech data to be used for a downlink transmission via a radio interface of said radio communications system; and
processing means (147) for carrying out a time alignment according to one of the methods 28 to 43.
